(19) United States
(12) Patent Application Publication
(10) Pub. No.: US 2019/0168243 A1
(43) Pub. Date: Jun. 6, 2019

(54) OUTWARD OPENING INJECTOR FOR EXHAUST AFTERTREATMENT SYSTEMS

(71) Applicant: Continental Automotive Systems, Inc., Auburn Hills, MI (US)

(72) Inventors: Willem Nicolaas Van Vuuren, Yorktown, VA (US); Michael J. Hornby, Williamsburg, VA (US); Stephen C. Bugos, Poquoson, VA (US)

(73) Assignee: Continental Automotive Systems, Inc., Auburn Hills, MI (US)

(21) Appl. No.: 16/210,409

(22) Filed: Dec. 5, 2018

Related U.S. Application Data
(60) Provisional application No. 62/595,514, filed on Dec. 6, 2017.

(51) Int. Cl. B05B 1/30; F01N 3/20; B05B 1/06; B05B 1/32

(52) U.S. Cl. CPC B05B 1/3073; F01N 3/206; F01N 2610/1453; B05B 1/326; F01N 2610/02; B05B 1/06

(57) ABSTRACT

A dosing unit includes a fluid injector having a valve seat; a valve needle movable within the fluid injector between a closed position in which an end engages with the valve seat to block a flow of fluid from exiting the fluid injector and an open position in which the end is spaced apart from the valve seat so as to allow fluid to exit the fluid injector. The valve body, the valve seat and the valve needle form an outwardly opening valve assembly. A pole piece fixedly is disposed within the valve body, and an armature is coupled to the valve needle upstream of the pole piece. A coil is disposed around the pole piece and the armature so as to generate a force when energized to move the armature toward the pole piece and to cause the valve needle to move from the closed to the open position.

### CROSS REFERENCE TO RELATED APPLICATION

The present application claims the benefit of U.S. provisional application 62/595,514, filed Dec. 6, 2017, and entitled “Outward Opening Injector for Exhaust Aftertreatment Systems,” the content of which is hereby incorporated by reference herein in its entirety.

### FIELD OF INVENTION

The invention relates generally a fluid injector for a Reductant Delivery Unit (RDU) and/or Diesel Delivery Unit (DDU) and, more particularly, to such a fluid injector having an outwardly opening injector valve.

### BACKGROUND

Stringent emissions legislation in Europe and North America is driving the implementation of new exhaust aftertreatment systems, particularly for lean-burn technologies such as compression-ignition (diesel) engines and stratified-charge spark-ignited engines (usually with direct injection) that are operating under lean and ultra-lean conditions. Exhaust aftertreatment technologies are currently in production that treat NOx under these conditions. One of these technologies comprises a catalyst that facilitates the reactions of ammonia (NH₃) with the exhaust nitrogen oxides (NOx) to produce nitrogen (N₂) and water (H₂O). This technology is referred to as Selective Catalytic Reduction (SCR). Ammonia is difficult to handle in its pure form in the automotive environment, therefore it is customary with these systems to use a liquid aqueous urea solution, typically at a 32% concentration of urea (CO (NH₂)₂). The solution is referred to as AUS-32, and is also known under its commercial names of AdBlue (EU), and DEF-Diesel Exhaust Fluid (USA). The urea is delivered to the hot exhaust stream and is transformed into ammonia prior to entry in the catalyst.

Because of a combination of increasing engine efficiency (resulting in low exhaust gas temperatures) and the need to enable NOx reduction very early in the certification cycles, automakers are increasingly turning toward so-called “close-coupled” exhaust system architectures—meaning installation of the SCR catalyst, and therefore also the injection point, much closer to the engine itself. As a result, mixing lengths—the distance from the injection point to the catalyst—are becoming much shorter. In certain cases, this means that the injected fluid needs to spread out to a wide area very rapidly in order to provide a good homogeneous delivery to the catalyst face.

Alternatively, systems are under development whereby active direct exhaust injection of hydrocarbon fluids is employed. The injected fuel is typically delivered to an oxidation catalyst and the resulting exothermic oxidation reaction increases the exiting exhaust gas temperature. This process helps accelerate the lightoff of the catalyst and in low speed, low load operating conditions helps maintain the exhaust temperatures above the catalyst lightoff temperature for optimized emissions conversion rates. There is a concern with state-of-the-art injection technologies described below that tip coking can occur that would obstruct flow passages and degrade the functionality of the injector.

Today's RDUs and DDUs are typically equipped with spray generators having thin disks with multiple orifice holes. The delivery units are typically equipped with solenoid-actuated valves. The solenoids include an armature-pole piece configuration wherein the armature action moves a connected valve element upon energizing of the solenoid coil. The movement of the valve element is “inward”, or away from the injector outlet. The fluid then proceeds through a thin disk with orifice holes which generates the desired spray shape and fluid flow rates. The inward-opening orifice-disk approach is typically limited in the cone angle of the spray, or in other words, the effective spray footprint. A typical maximum value for these designs is a cone angle of 30°, within which 90% of the spray is contained.

### SUMMARY

In contrast to existing DDU injector designs which utilize a passively controlled, outward-opening poppet and a remotely located solenoid control valve, example embodiments of the present disclosure describe the implementation of a solenoid-controlled, outward-opening needle configured to generate relatively wide cone angle sprays while also being capable to resist hydrocarbon coking effects. This should allow for more flexibility in the types of sprays that can be provided for close-coupled AUS-32 and exhaust hydrocarbon dosing applications.

Example embodiments of the present disclosure overcome shortcomings of existing RDUs and DDUs and satisfy a significant need for an improved delivery unit having an enhanced spray cone angle. In accordance with an example embodiment, there is shown an after-treatment fluid dosing device, including a fluid injector having an inlet port for receiving a fluid, an outlet port for discharging the fluid received by the inlet port, and a valve body extending between the inlet port and the outlet port, the valve body having a through-bore defining a flow path for the fluid through the fluid injector. The fluid injector further includes a valve seat disposed at the outlet port, a valve needle having a first end and a second end and being movable within the valve body between a closed position in which the second end engages with the valve seat to block a flow of fluid from exiting the outlet port and an open position in which the second end is spaced apart disposed in a downstream direction, relative to the flow of fluid through the fluid injector, from the valve seat so as to allow fluid to exit the fluid injector at the outlet port. The valve body, the valve seat and the valve needle form an outwardly opening valve assembly.

The fluid injector further includes an actuator unit having a pole piece fixedly disposed within the valve body, an armature coupled to the valve needle, disposed upstream of the pole piece relative to the flow of fluid through the fluid injector, and axially movable within the valve body, and a coil coupled to the valve body and disposed around at least part of the pole piece and the armature such that the coil generates a force when energized to move the armature toward the pole piece so as to cause the valve needle to move from the closed position to the open position. A first spring is disposed between and contacting the pole piece and the armature so as to urge the armature away from the pole piece and move the valve needle to the closed position when the coil is no longer energized.

In an example embodiment, the valve seat may include a bore defined through the valve seat and the fluid flows through the bore and around the second end of the valve needle when the valve needle is in the open position, the bore having an inverse conical shape. The actuator unit may be disposed in a longitudinally central region of the fluid injector.

In an example embodiment, the valve needle includes a largely cylindrical shape and the second end of the valve needle includes a sealing surface which contacts the valve seat when the valve needle is in the closed position so as to prevent fluid from exiting the fluid injector, with the sealing surface being angled relative to a longitudinal axis of the needle valve. The valve seat includes a contact surface which at least partly defines the bore of the valve seat and engages with the sealing surface of the valve needle when the valve needle is in the closed position, and the contact surface is angled relative to the longitudinal axis of the needle valve.

In another example embodiment, a tube adjustably is disposed between the inlet port and the armature, and a calibration spring is disposed between the tube and the armature, the calibration spring urging the armature towards the pole piece.

The after-treatment fluid dosing device is a reductant delivery unit or a diesel delivery unit. A shield surrounds at least a part of the fluid injector, the shield including upper and lower shields and a mount coupled to a downstream end portion of the fluid injector, for mounting the along an exhaust pipe of a vehicle.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a cross-sectional view of a fluid injector for after-treatment dosing systems, according to an example embodiment;

FIG. 2 is an enlarged cross-sectional view of the fluid outlet of the fluid injector of FIG. 1;

FIG. 3 is an enlarged elevational view of an end of a fluid valve needle of the fluid injector of FIG. 1;

FIG. 4 is a cross-sectional view of an air-cooled after-treatment dosing unit having the fluid injector of FIG. 1; and

FIG. 5 is a cross-sectional view of a liquid-cooled after-treatment dosing unit having the fluid injector of FIG. 1.

### DETAILED DESCRIPTION

The following description of the preferred embodiment(s) is merely exemplary in nature and is in no way intended to limit the invention, its application, or uses.

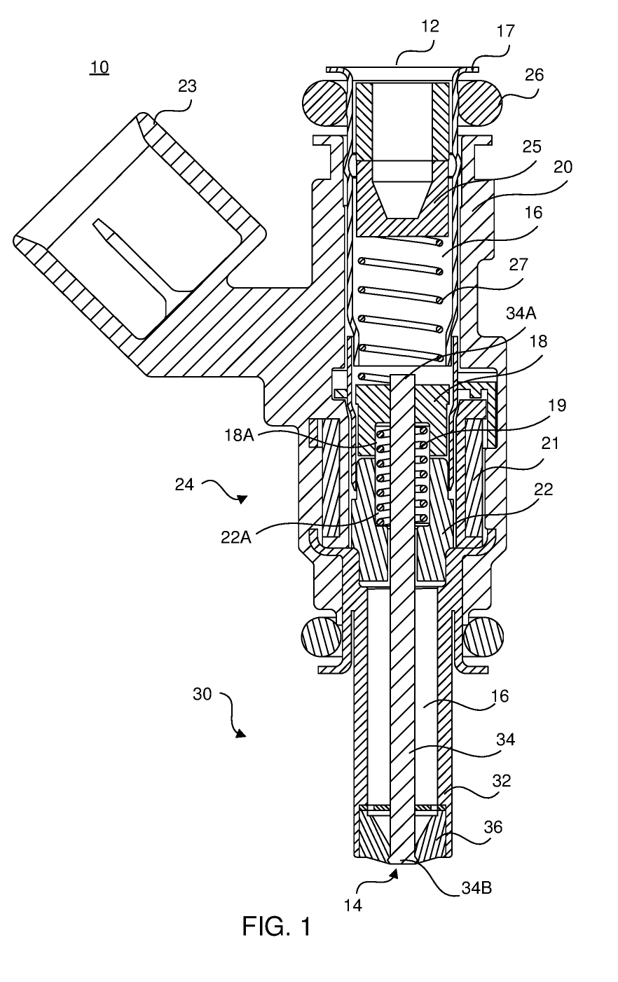

With reference to FIG. 1, a fluid injector according to an embodiment of the present disclosure is shown, generally at 10. Fluid injector 10 is configured to connect to a source of reductant (not shown) when fluid injector 10 is configured as, and forms part of, an RDU of a Selective Catalytic Reduction (SCR) system of a vehicle. In addition or in the alternative, fluid injector 10 is configured to be connected to a supply of diesel fuel (not shown) when fluid injector 10 is configured as, and forms part of, a DDU of a diesel dosing system.

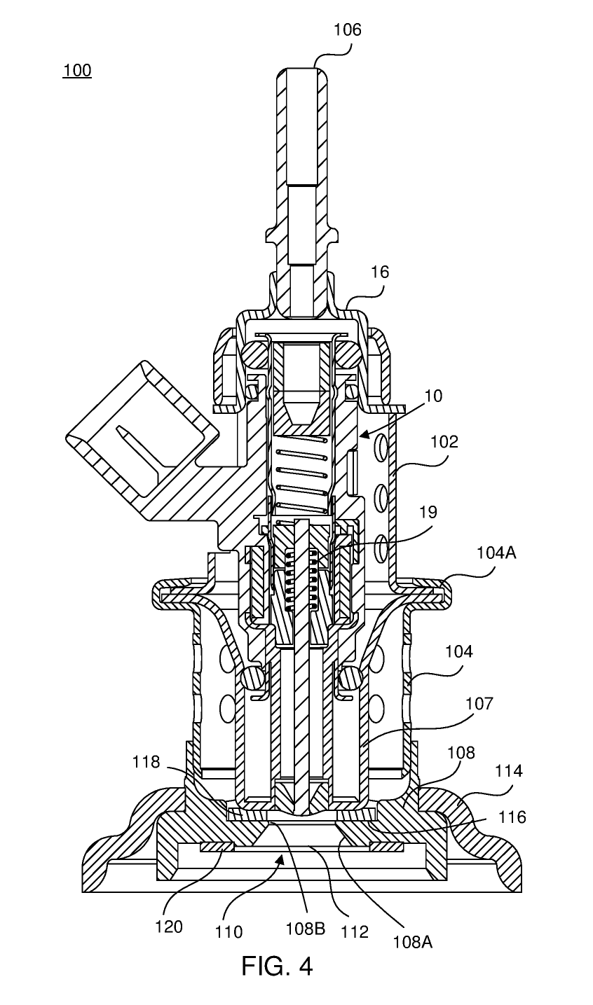

A portion of an inlet tube 17 is disposed within a body 20. A primary seal member 26, such as an elastomer O-ring, surrounds part of the inlet tube 17 so as to provide a seal between the inlet tube 17, the inlet cup 16 (FIG. 4), and body 20.

The fluid injector 10 includes a fluid inlet 12 at an upstream end of the injector, a fluid outlet 14 at a downstream end of the injector, and a fluid passageway 16 extending from fluid inlet 12 to fluid outlet 14. The fluid passageway 16 may be defined in part by inlet tube 17 and a valve body, as described in greater detail below. Fluid injector 10 is of the solenoid-operated type, having an armature 18 operated by a coil 21. A pole piece 22 is fixedly disposed within fluid injector 10, such as within at least part of inlet tube 17. As shown in FIG. 1, armature 18 is disposed upstream of pole piece 22, relative to a direction of fluid flow from fluid inlet 12 to fluid outlet 14. An electromagnetic force is generated by electric current from a vehicle's electronic control unit (not shown) through coil 21 via an electrical interface 23 of fluid injector 10. When the coil 21 is energized by passing an electric current, armature 18 moves in a downstream direction toward fixed pole piece 22. The pole piece 22, armature 18 and coil 21 may be considered to be part of, or otherwise form, an actuator unit, generally indicated 24, that controls fluid flow exiting fluid injector 10 via fluid outlet 14, as described in greater detail below.

Fluid injector 10 includes a valve assembly, generally indicated at 30, which is coupled to and cooperates with the actuator unit for passing and blocking the flow of fluid out of fluid outlet 14. Valve assembly 30 includes a valve body 32 having a cavity defined therethrough, a moveable valve needle 34 disposed at least partly in the cavity of valve body 32, and valve seat 36 disposed at fluid outlet 14 of fluid injector 10. The cavity of valve body 32 defines at least part of fluid passageway 16 through which fluid flows from fluid inlet 12 to fluid outlet 14. Elongated valve needle 34 includes a first end portion 34A, in this case the upstream end portion, which is connected to armature 18 so as to be movable therewith, and a second end portion 34B which is engageable with valve seat 36. Valve needle 34 and armature 18 are movably disposed within fluid injector 10 along the longitudinal axis thereof. Specifically, valve needle 34 is movable between a closed position in which second end portion 34B of valve needle 34 is sealingly engaged with valve seat 36 so as to prevent fluid from exiting fluid injector 10 from fluid outlet 14, and an open position in which second end portion 34B of valve needle 34 is spaced apart from valve seat 36 so that fluid flows through valve seat 36 and around the second end portion 34B of valve needle 34. In an example embodiment, armature 18 is connected to valve needle 34 at or near first end portion 34A thereof.

With continued reference to FIG. 1, fluid injector 10 includes a return spring 19, which is disposed between pole piece 22 and armature 18 so as to present a bias force to armature 18 in an upstream direction towards fluid inlet 12, relative to the direction of fluid flow through fluid injector 10. In particular, armature 18 includes a pocket 18A defined from a lower, downstream surface of armature 18. In addition, pole piece 22 includes a pocket 22A defined from an upstream surface of pole piece 22. Pockets 18A and 22A may each be laterally (radially) centrally located and face each other in fluid injector 10. Return spring 19 is disposed within pockets 18A and 22A, and is compressed against inner radial surfaces of pockets 18A and 22A so as to urge armature 18 towards fluid inlet 12. In this way, return spring 19 moves armature 18 towards fluid inlet 12 when coil 21 is no longer energized, so that valve needle 34 is returned to the closed position to prevent fluid from further exiting fluid injector 10.

In the example embodiment illustrated in FIG. 1, fluid injector 10 further includes a dynamic flow adjustment mechanism for regulating the movement speed of armature 18 (and thus valve needle 34) during opening and closing of valve assembly 30. Specifically, the dynamic flow adjustment mechanism includes an adjustment tube 25 and calibration spring 27. Adjustment tube 25 is disposed within fluid passageway 16 of inlet tube 17 proximal to fluid inlet 12. Adjustment tube 25 may be adjustably positioned within inlet tube 17 but once positioned remains fixed within fluid injector 10. Adjustment tube 25 may include or be otherwise associated with a filter for filtering fluid entering fluid inlet 12. Calibration spring 27 is disposed between and contacts a lower (downstream) surface of adjustment tube 25 and an upper (upstream) surface of armature 18. Calibration spring 27 is configured to present a downward (downstream) bias force on armature 18 such that the total spring force by return spring 19 and calibration spring 27 is relatively easily adjusted at the time of manufacture of fluid injector 10.

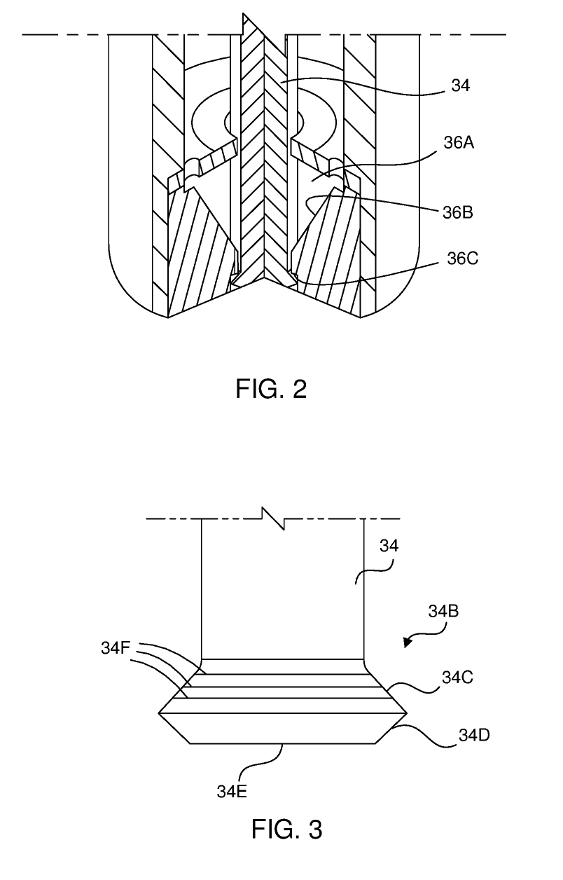

FIG. 2 illustrates in greater detail fluid outlet 14. As can be seen, valve needle 34 extends through a throughbore 36A of valve seat 36. Throughbore 36A is defined longitudinally through valve seat 36 and forms part of fluid passageway 16 which extends from fluid inlet 12 to fluid outlet 14. Valve seat 36 may include a surface 36B forming an inverted conical shaped portion for throughbore 36A, funneling the fluid to fluid outlet 14, and a sealing surface 36C forming an exit portion for sealingly engaging second end portion 34B of valve needle 34.

Best shown in FIG. 3, second end portion 34B of valve needle 34 includes a sealing surface 34C which sealingly engages with sealing surface 36C of valve seat 36 when valve needle 34 is in the closed position. In an example embodiment, sealing surface 34C of valve needle 34 extends laterally (radially) and/or is tapered outwardly in a downstream direction, forming a frusto-conical shape. Second end portion 34B of valve needle 34 may further include a surface 34D which is downstream of sealing surface 34C and extends radially inwardly and/or is inwardly tapered from sealing surface 34C in a downstream direction. In an example embodiment, surface 34D has an inverted frusto-conical shape. In other words, sealing surface 34C forms an oblique angle with respect to a longitudinal axis of injector 10. In an example embodiment, the oblique angle is configured such that the output spray of fluid from injector 12 has a conical shape with a cone angle of at least 70 degrees, and particularly at least 80 degrees, such as at least 90 degrees. Surface 34E is largely flat and/or planar and forms the end surface of valve needle 34.

Sealing surface 34C of valve needle 34 may include scribe lines 34F defined along sealing surface 34C. Each scribe line 34F may have a largely annular shape on sealing surface 34C.

The operation of fluid injector 10 is as follows. Fluid, whether a reductant when fluid injector 10 is configured as a RDU or diesel fuel when fluid injector 10 is configured as a DDU, enters fluid injector 10 from fluid inlet 12. When coil 21 is not energized, there is no electromagnetic force acting on armature 18 such that return spring 19 biases armature 18 and moves the armature towards fluid inlet 12 and away from pole piece 22, which also moves valve needle 34 towards fluid inlet 12 so that second end portion 34B, and particularly sealing surface 34C, sealingly engages with sealing surface 36C of valve seat 36 so that valve needle 34 is in the closed position and prevents fluid from exiting fluid injector 10 via fluid outlet 14. When coil 21 is energized, an electromagnetic force is generated by coil 21 which moves armature 18 in a downstream direction towards pole piece 22. The downstream movement of armature 18 causes valve needle 34 to move so that sealing surface 34C of valve needle 34 disengages from sealing surface 36C of valve seat 36, thereby allowing fluid in fluid injector 10 to pass through through-bore 36A of valve seat 36 and exit fluid injector 10. The fluid exiting fluid injector 10 through fluid outlet 14 has a generally conical shape, based in part upon the dimensions of valve seat 36 and sealing surface 34C of valve needle 34.

As mentioned, fluid injector 10 is adapted for use in after-treatment dosing units, such as RDUs and DDUs. FIG. 4 illustrates fluid injector 10 forming part of a passive or air-cooled dosing unit 100. Dosing unit 100 includes a housing formed as an upper housing 102 and a lower housing 104. Dosing unit 100 further includes a fluid inlet 106 for receiving fluid, e.g., a reductant or diesel fuel, which passes through fluid injector 10 and is selectively discharged from fluid outlet 14 thereof. Both upper housing 102 and lower housing 104 include a plurality of through-holes defined along the housings for allowing air to pass though the housings and regulate temperatures internal to the housings. Fluid injector 10 is disposed in an interior carrier 107. Upper housing 102 and lower housing 104 are connected to carrier 107, such as by folding a tang 104A of an end portion of lower housing 104 so as to surround and clamp in place end portions of upper housing 102 and carrier 107.

Dosing unit 100 further includes an injector flange 108 which receives therein the downstream end of lower housing 104. Injector flange 108 includes an internal surface structure, generally indicated at 110, that defines a flange outlet 112 that delivers fluid into a vehicle exhaust flow path. Flange 108 interfaces with a boss (not shown) that is welded to the vehicle exhaust. A bracket 114 is disposed over a portion of flange 108 and is secured to the vehicle exhaust line via bolts or other fasteners (not shown) so as to fix dosing unit 110 to the exhaust line.

The internal surface structure 110 of flange 108 also includes a largely frusto-conical surface 108A that is joined with at least one radial surface 108B. In the embodiment, the frusto-conical surface 108A defines the open end of the flange 108 and is joined with the radial surface 108B, with the radial surface 108B being joined directly with a gasket shelf surface 116 of the flange 108. The gasket shelf surface 116 is disposed generally perpendicular with respect to a longitudinal axis of the injector assembly 10.

Dosing unit 100 further includes an isolating gasket 118 which rests on the gasket shelf surface 116 to seal flange 108 with respect to carrier 107, and a second isolating gasket 120 disposed between a downstream end of flange 108 and an upstream end of the exhaust boss. Both isolating gaskets 118 and 120 serve to thermally isolate fluid injector 10 from high temperatures of the exhaust stream in the exhaust flow path of the vehicle, by blocking heat flow paths from the exhaust pipe through the exhaust boss and flange 108 to fluid injector 10. Dosing unit 100 thus uses isolating gaskets 118 and 120 as well as cooling airflow around dosing unit 100 to keep temperatures of fluid injector 10 from high temperatures which may damage fluid injector 10.

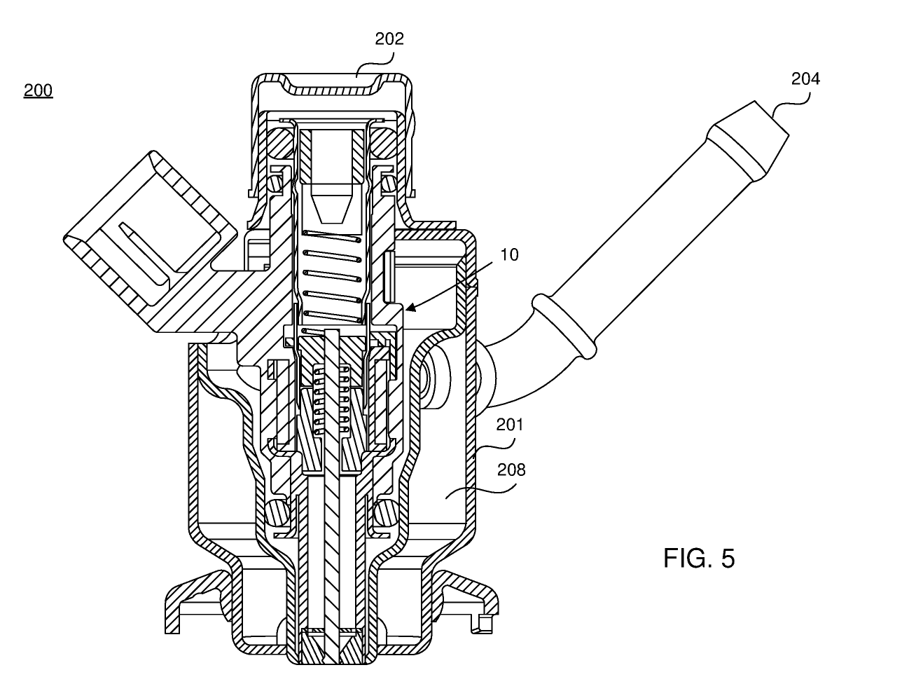

Passively cooled dosing unit 100 is utilized for applications in which mounting locations along the exhaust pipe have lower temperatures and available cooling airflow. For mounting locations where the ambient temperature and the exhaust gas temperatures are higher, an actively cooled dosing unit may be used. Referring to FIG. 5, there is shown an actively cooled dosing unit 200 according to another example embodiment. Dosing unit 200 includes fluid injector 10 disposed therein. Dosing unit 200 is actively cooled by passing coolant around fluid injector 10 so as to maintain temperatures thereof within a desirable temperature range. Dosing unit 200 includes a housing 201 having a fluid inlet 202 for receiving fluid, e.g., a reductant or diesel fuel, which flows into fluid injector 10 for being selectively sprayed into the exhaust flow path of the corresponding vehicle. Housing 201 further includes a coolant inlet 204 for receiving coolant from a coolant source, and a coolant outlet (not shown in FIG. 5) for returning coolant to the coolant source for recirculation. Housing 201 also includes a coolant jacket 208 which is fluidly coupled to coolant inlet 204 and the coolant outlet. Coolant jacket 208 is disposed around fluid injector 10, and particularly around the portions of fluid injector 10 closest to the exhaust pipe. As shown in FIG. 5, coolant jacket 208 extends to or nearly to the bottom or downstream end of fluid injector 10. Actively cooled dosing unit 200 includes a V-clamp mount for mounting dosing unit 200 directly to the vehicle exhaust pipe.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An exhaust after-treatment fluid dosing device, comprising:
a fluid injector including
a fluid inlet for receiving a fluid;
a fluid outlet for discharging the fluid received at the fluid inlet;
a body extending between the fluid inlet and the fluid outlet, the body at least in part defining a flow path for the fluid through the fluid injector;
a valve seat, the valve seat disposed at or near the fluid outlet;
a valve needle having a first end portion and a second end portion and being movable within the body between a closed position in which the second end portion engages with the valve seat to block a flow of fluid from exiting the fluid injector via the fluid outlet, and an open position in which the second end portion is spaced apart and extends in a downstream direction, relative to the flow of fluid through the fluid injector, from the valve seat so as to allow fluid to exit the fluid injector through the fluid outlet, the valve seat and the valve needle at least partly forming an outward opening valve assembly;
an actuator unit including a pole piece fixedly disposed within the body, an armature connected to the valve needle, disposed upstream of the pole piece relative to the flow of fluid through the fluid injector, and axially movable within the body, and a coil coupled to the body and disposed around at least part of the pole piece and the armature such that the coil generates a force when energized to move the armature toward the pole piece so as to cause the valve needle to move from the closed position to the open position; and
a first spring disposed between and contacting the pole piece and the armature so as to urge the armature away from the pole piece and move the valve needle to the closed position when the coil is no longer energized, the first spring forming part of the outward opening valve assembly.

2. The exhaust after-treatment fluid dosing device of claim 1, wherein the valve seat includes a bore defined through the valve seat and the fluid flows through the bore and around the second end portion of the valve needle when the valve needle is in the open position, the bore including an inverse conical shape.

3. The exhaust after-treatment dosing device of claim 1, wherein the actuator unit is disposed in a longitudinally central region of the fluid injector.

4. The exhaust after-treatment fluid dosing device of claim 1, wherein the valve needle includes a largely cylindrical shape and the second end portion of the valve needle includes a sealing surface which contacts the valve seat when the valve needle is in the closed position so as to prevent fluid from exiting the fluid injector, the sealing surface being at an oblique angle relative to a longitudinal axis of the needle valve.

5. The exhaust after-treatment fluid dosing device of claim 4, wherein the valve seat includes a contact surface which at least partly defines the bore of the valve seat and engages with the sealing surface of the valve needle when the valve needle is in the closed position, and the contact surface is at an oblique angle relative to the longitudinal axis of the valve needle.

6. The exhaust after-treatment fluid dosing device of claim 1, wherein the after-treatment fluid dosing device is a reductant delivery unit or a diesel delivery unit.

7. The exhaust after-treatment fluid dosing device of claim 1, further comprising a dosing unit housing surrounding at least a part of the fluid injector, the dosing unit housing comprising an upper housing and a lower housing, and a flange coupled to the lower housing, for mounting the fluid injector along an exhaust pipe of a vehicle.

8. The exhaust after-treatment fluid dosing device of claim 7, wherein the dosing unit housing includes one or more apertures for allowing air flow to and from the fluid injector, or forms at least part of a sealed coolant jacket configured for passing a liquid coolant around the fluid injector.

9. An exhaust after-treatment dosing device, comprising:
a fluid injector having
a fluid inlet for receiving a fluid and a fluid outlet for discharging the fluid received by the fluid inlet;
a body extending between the fluid inlet and the fluid outlet, the body at least partly defining a fluid passageway for the fluid through the fluid injector;
a valve seat, the valve seat disposed along the body at the fluid outlet;
a valve needle having first and second ends and movable within the body between a closed position in which the second end engages with the valve seat to block a flow of fluid from exiting the fluid outlet, and an open position in which the second end is spaced apart from the valve seat so as to allow fluid to exit the fluid injector at the fluid outlet, wherein the valve seat and the valve needle at least partly form an outwardly opening valve assembly;
a pole piece fixedly disposed to the body;
an armature connected to the valve needle, disposed upstream of the pole piece relative to the flow of fluid through the fluid injector, and axially movable within the body;
a solenoid coupled to the body and disposed around at least part of the pole piece and at least part of the armature such that the solenoid generates a force when energized to move the armature toward the pole piece so as to cause the valve needle to move from the closed position to the open position and the fluid to exit the fluid injector; and
a bias member disposed between and contacting the pole piece and the armature so as to urge the armature away from the pole piece and move the valve needle to the closed position when the solenoid is no longer energized, the bias member being part of the outwardly opening valve assembly.

10. The exhaust after-treatment dosing device of claim 9, wherein the after-treatment dosing device is one of a reductant delivery unit and a diesel delivery unit.

11. The exhaust after-treatment dosing device of claim 9, wherein the valve seat includes a bore defined through the valve seat and the fluid flows through the bore and around the second end of the valve needle when the valve needle is in the open position.

12. The exhaust after-treatment dosing device of claim 11, wherein the valve needle includes a largely cylindrical shape and the second end of the valve needle includes a sealing surface which contacts a surface of the valve seat when the valve needle is in the closed position so as to prevent fluid from exiting the fluid injector, the sealing surface being at an oblique angle relative to a longitudinal axis of the needle valve.

13. The exhaust after-treatment dosing device of claim 12, further comprising a housing surrounding at least a part of the fluid injector, the housing comprising an upper shield and a lower shield; and a mounting flange for mounting the fluid injector along an exhaust pipe of a vehicle.

14. The exhaust after-treatment dosing device of claim 10, wherein the mounting flange is coupled to a downstream end portion of the fluid injector, the mounting flange configured to connect the fluid injector to an exhaust pipe of a combustion engine, and the after-treatment dosing device further comprises a gasket disposed between the fluid injector and the mounting flange, the gasket serving to at least partially thermally isolate the fluid injector from the exhaust pipe.

15. The exhaust after-treatment dosing device of claim 14, further comprising a second gasket configured for being disposed between the mounting flange and the exhaust pipe.

16. The exhaust after-treatment dosing device of claim 13, wherein the housing comprises a coolant inlet for receiving a coolant from a coolant source, a coolant outlet for returning the received coolant to the coolant source, and a coolant jacket in fluid communication between the coolant inlet and the coolant outlet, the coolant jacket disposed at least partly around the fluid injector for cooling same.
